(19) United States
(12) Patent Application Publication
(10) Pub. No.: US 2006/0215138 A1
(43) Pub. Date: Sep. 28, 2006

(54) Laser beam pattern generator with a two-axis scan mirror

(75) Inventor: Xinbing Liu, Acton, MA (US)

Correspondence Address: RATNERPRESTIA, P O BOX 980, VALLEY FORGE, PA, 19482-0980, US

(73) Assignee: Matsushita Electric Industrial Co., Ltd.

(21) Appl. No.: 11/087,028

(22) Filed: Mar. 22, 2005

(51) Int. Cl. G03B 27/52

(52) U.S. Cl. 355/55

(57) ABSTRACT

An optical pattern generator for use in grayscale photolithography is provided with an optical source to generate a light beam, an optical modulator optically coupled to the optical source to modulate the power of the light beam, a two dimensional scanning mirror optically coupled to the optical modulator to reflect the light beam, a lens optically coupled to the two dimensional scanning mirror for focusing the reflected light beam to a beam spot on a surface of a substrate coated with photoresist, and control means electrically coupled to the two dimensional scanning mirror to control a tilt of the two dimensional scanning mirror about two substantially orthogonal axes to scan the beam spot over a surface of the substrate in two substantially orthogonal dimensions with sub-micron accuracy.

### FIELD OF THE INVENTION

The present invention relates to the field of photolithography and, more particularly to a grayscale photolithography method and apparatus.

### BACKGROUND OF THE INVENTION

In the field of grayscale photolithography, a laser beam pattern generator scans over a surface of a substrate coated with a photoresist material to form a three-dimensional pattern in the photoresist material. The substrate may be, for example, a mold for an optical lens or a semiconductor wafer.

FIG. 1 illustrates a grayscale photolithography apparatus comprising a laser beam pattern generator 10. As shown in FIG. 1, the laser beam pattern generator 10 includes a light source 12 that generates a light beam 13 and directs the light beam 13 to an optical modulator 14, which modulates the power of the light beam 13. The modulated light beam 13 is then directed to a polarizing beam splitter 22, via steering mirrors 16 and 18. The polarizing beam splitter 22 directs the light beam 13 through a quarter waveplate 24 to a one-dimensional scanning mirror 28. The one-dimensional scanning mirror 28 reflects the light beam 13 along a single axis 29 back through the quarter waveplate 24 and to the polarizing beam splitter 22. The polarizing beam splitter 22 reflects the light to a converging lens 30. The converging lens 30 focuses the light beam 13 onto a surface of a substrate 32 coated with a layer of photoresist material 35. The focused light beam forms a beam spot 33 on the surface of the substrate, exposes the photoresist material 35.

The one-dimensional scanning mirror 28 rotates about a single axis 29 to position the beam spot 33, thereby exposing the photoresist material 35 along that axis, e.g. the x-axis. An x-y-axis translation stage 36 translates the position of the substrate 32 to expose the photoresist material 35 along a second axis (e.g. the y-axis) perpendicular to the x-axis. In addition, the x-y axis translation stage 36 may reposition the substrate in the x-direction for large movement, e.g., transitioning to a new scan area. The combination of rotating the one-dimensional scanning mirror 28 and translating the x-y translation stage 36 exposes the photoresist material 35 in two orthogonal directions (x and y) in a raster scan pattern 270 (illustrated in FIG. 2a). The power of the light beam 13, modulated by the optical modulator 14, influences the exposure depth of the photoresist material 35 along the z-axis, orthogonal to the x and y axes. A laser interferometer 38 detects the position of the x-y-axis translation stage 36 and adjusts the position of the x-y-axis translation stage 36 as necessary.

An example of a raster scan pattern 270 is illustrated in FIG. 2a. The raster scan pattern 270 includes horizontal scan lines separated by vertical steps along the y-axis. The horizontal scan lines are uniformly spaced with respect to one another. The separation between the scan lines, designated by dimension “C”, is typically on the order of a tenth of a micron or greater. As the separation between the scan lines approaches a micron or smaller however, the x-y translation stage 36 is not capable of smooth translation which results in non-uniform scan lines.

FIG. 2b illustrates a non-uniform raster scanning pattern 271 scanned by the laser beam pattern generator 10. The separation between the scan lines in this embodiment is desirably on the order of a micron or less in length. This separation between the scan lines, designated by dimensions F and F′, may change from scan line to scan line. The non-uniform vertical scan line steps are caused by the inability of the x-y-axis translation stage 36 to precisely translate uniformly even steps at the micron or submicron accuracy level. This lack of precision results from micro-vibrations stemming from imperfections in the micro-stepping motors that drive the x-y translation stage 36. Hysteresis and backlash in the motion of the x-y translation stage 36 may additionally complicate the precision of the x-y translation stage 36. The interferometer 38 can adjust the position of the x-y translation stage during each vertical step along the y-axis, however, as each step “F” represents a micron or less in distance, the detection and adjustment of the position of the x-y translations stage 36 is time consuming and cumbersome.

Modern optical devices and semiconductor wafers comprise features that are typically on the order of a micron or less in size, thereby requiring a highly precise and efficient laser beam pattern generator. Accordingly, there is a need for laser beam pattern generators that are not subject to the aforementioned limitations.

### SUMMARY OF THE INVENTION

According to one aspect of the invention, an optical pattern generator for use in grayscale photolithography is provided with an optical source to generate a light beam. An optical modulator is optically coupled to the optical source to modulate the power of the light beam. A two dimensional scanning mirror is optically coupled to the optical modulator to reflect the light beam. A lens is optically coupled to the two dimensional scanning mirror for focusing the reflected light beam to a beam spot on a surface of a substrate coated with photoresist. Control means are electrically coupled to the two dimensional scanning mirror to control a tilt of the two dimensional scanning mirror about two substantially orthogonal axes to scan the beam spot over a surface of the substrate in two substantially orthogonal dimensions with sub-micron accuracy.

According to another aspect of the invention, a method is provided for generating a grayscale pattern having sub-micron accuracy on a substrate coated with photoresist. The method includes the step of generating a light beam, modulating the power of the light beam and reflecting the modulated light beam off of a two dimensional scanning mirror. The method further includes the step of focusing the reflected light beam to a beam spot on the substrate and scanning the beam spot on the surface of the substrate in two substantially orthogonal dimensions with sub-micron accuracy by pivoting the two dimensional mirror about two substantially orthogonal axes.

According to yet another aspect of the invention, an optical pattern generator for use in grayscale photolithography provides a control means electrically coupled to a two dimensional scanning mirror to control a tilt of the two dimensional scanning mirror about two substantially orthogonal axes to scan the beam spot along a scanning pattern over the surface of the substrate, wherein the scanning pattern includes at least one curved portion.

Yet another aspect of this invention provides a method for generating a grayscale pattern on a substrate having a surface coated with photoresist comprising the step of scanning the light beam over the surface of the substrate in a scanning pattern that includes at least one curved scan portion by pivoting a two dimensional scanning mirror about two substantially orthogonal axes.

### BRIEF DESCRIPTION OF THE DRAWINGS

FIG. 1 is a block diagram of a prior art apparatus for scanning a light beam;

FIG. 2a is a diagram of a raster scan field generated by the apparatus of FIG. 1;

FIG. 2b is a diagram of a raster scan field with non-uniform scan lines generated by the apparatus of FIG. 1;

FIG. 3 is a block diagram of an apparatus for scanning a light beam according to an aspect of the present invention;

FIG. 4a is a diagram of a raster scan field generated by the apparatus of FIG. 3 in accordance with an aspect of the present invention;

FIG. 4b is a diagram of multiple raster scan fields generated by the apparatus of FIG. 3 in accordance with an aspect of the present invention;

FIG. 5a is a diagram of a circular wedge scan pattern generated by the apparatus of FIG. 3 in accordance with an aspect of the present invention;

FIG. 5b is a diagram of a closed curve scan pattern generated by the apparatus of FIG. 3 in accordance with an aspect of the present invention;

FIG. 6a is a flowchart illustrating exemplary steps for generating a grayscale pattern having sub-micron accuracy on a substrate coated with photoresist in accordance with an aspect of the present invention; and

FIG. 6b is a flowchart illustrating exemplary steps for generating another grayscale pattern having sub-micron accuracy on a substrate coated with photoresist in accordance with an aspect of the present invention.

### DETAILED DESCRIPTION OF THE INVENTION

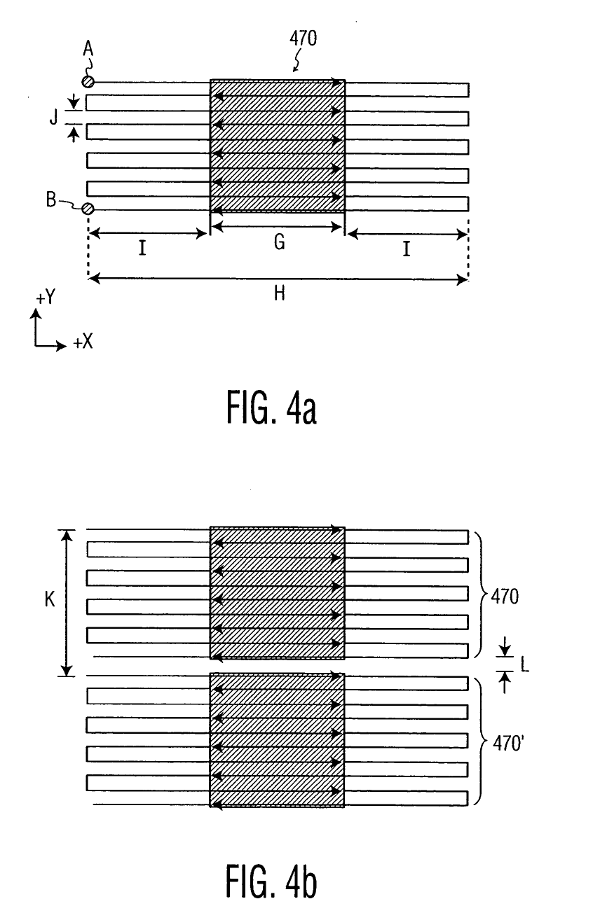

Referring to the overall structure of one exemplary embodiment, FIG. 3 illustrates a laser beam pattern generator designated generally by the number “110”. Generally, the laser beam pattern generator is provided with an optical source to generate a light beam, an optical modulator optically coupled to the optical source to modulate the power of the light beam, a two dimensional scanning mirror optically coupled to the optical modulator to reflect the light beam, and a lens optically coupled to the two dimensional scanning mirror for focusing the reflected light beam to a beam spot on a surface of a substrate coated with photoresist.

More specifically, FIG. 3 illustrates an exemplary laser beam pattern generator 110 including a two-dimensional scanning mirror 128. In the illustrated laser beam pattern generator 110 a light source 112 generates a linearly polarized light beam 113 and directs the light beam 113 to an optical modulator 114. The optical modulator 114 receives and modulates the power of the light beam 113 and directs the modulated light beam 113 towards a steering mirror 116. The steering mirror 116 reflects the light beam towards another steering mirror 118, which reflects the light beam to a lens 120. The functionality of the lens 120 will be described in further detail later.

The light beam 113 is then directed to a beam splitter 122. The beam splitter 122 directs the light beam based upon the polarization of the light beam 113. In an exemplary embodiment, the beam splitter 122 is a polarizing beam splitter that passes light having a first orientation and reflects light having a second orientation orthogonal to the first orientation. The light beam 113 is polarized such that the beam splitter 122 allows the light beam 113 to pass therethrough without reflection to a quarter waveplate 124. The light beam 113 passes thru the quarter waveplate 124 to an image relay lens 126 which focuses the light beam 113 onto a two-dimensional scanning mirror 128, which is capable of rotating about two orthogonal axes 129, 131.

The two-dimensional scanning mirror 128 reflects the light beam 113 back through the lens 126 and the quarter waveplate 124. By passing the light beam 113 through the quarter waveplate 124 twice, the linear polarization of the light beam switches from one orthogonal component to the other. Accordingly, beam splitter 122 now reflects the light beam 113 and directs the light beam 113 to a converging lens 130. The converging lens 130 focuses the light beam 113 onto the surface of the substrate 132 to form a beam spot 133 thereon.

The image relay lens 126 projects the image on the two-dimensional scanning mirror 128 to the input aperture of the converging lens 130 (a microscope objective). Because the beam spot on the two-dimensional scanning mirror 128 is stationary, image-relaying the spot by lens 126 to the input aperture of lens 130 ensures the input aperture does not clip the beam.

The surface of the substrate 132 is coated with photoresist material 135 which is exposed by the beam spot 133. The process of exposing the photoresist material 135 using a laser beam is commonly known in the art as laser writing. It is also commonly known in the art that the power and/or wavelength of the beam spot 133 influences the degree of photoresist exposure. The power of the beam spot 133 is controlled by the optical modulator 114, which adjusts the power of the light beam 113 to either write or merely scan along the surface of the substrate 132. The optical modulator 114 is controlled by an external source (not shown). The optical modulator 114 of the exemplary embodiment may optionally be an acousto-optic modulator or an electro-optic modulator.

The optical modulator 114 facilitates the formation of three-dimensional grayscale patterns. It is commonly known in the art that grayscale photolithography is used in fabricating asymmetric micro-optic structures. This technique enables complex optical structures to be fabricated, for example, lens arrays, kinoform and Fresnel lens patterns, concave and off-axis lenses, and diffraction gratings. In the exemplary embodiment, grayscale lithography enables patterning within the material depth of the photoresist layer 135. In practice, the optical modulator 114 modulates the power of the light beam 113, thus, modulating the power of the beam spot 133 impinging on the surface of the photoresist material 135. The power of the beam spot 133 influences the level of exposure along the depth (z-axis) of the photoresist material 135, as does the size of the beam spot. In other words, the greater the intensity of the beam spot, the deeper the exposure along the z-axis depth of the photoresist material 135. The combined actions of the optical modulator 114 and the two-dimensional scanning mirror 128 thereby form a three-dimensional exposure pattern in the photoresist material 135.

Still referring to FIG. 3, a camera 142 images the surface of the photoresist material and thereby monitors the size and position of a beam spot formed on that surface. According to this exemplary embodiment, the camera 142 is used to monitor the position, size and shape of a beam spot relative to a desired starting point on the surface of the photoresist material 135. The starting point may be positioned relative to edges of the substrate and/or fiducial marks on the substrate. In order to enable the camera 142 to monitor the position, size and shape of the beam spot without exposing the photoresist material, the laser beam pattern generator 110 may utilize an additional light source, i.e. a focus-assist laser 150, to provide a second light source. The focus assist laser 150 emits a light beam 152 of a different wavelength than the light beam 113. The light beam 152 does not expose the photoresist material 135. This is because the wavelength of light beam 152 is desirably chosen such that photoresist material 135 is not sensitive to the wavelength of light beam 152. Light beam 152 is directed by mirror 151 and focused onto the surface of substrate 132 by lens 130 to form another beam spot 137 thereon. Camera 142 may monitor the size and position of beam spot 137.

In practice, steering mirror 151 translates beam spot 137 such that beam spot 137 of focus assist light beam 152 may be aligned with beam spot 133 of light beam 113. Desirably, this alignment may be accomplished on a surface other than the photoresist and with two dimensional scanning mirror 128 in a predetermined initial position, for example an unbiased position. The focus of beam spot 133 may then be adjusted to coincide with the focus of beam spot 137 using the beam matching lens 120. The end-user may utilize the camera to monitor the sizes and positions of these beam spots during this calibration.

Beam spot 137 may then aligned with the starting point of the scanning pattern on the surface of the photoresist using the x-y-axis translation stage 136. This alignment may desirably be done with laser beam 113 off, thus allowing alignment without exposing the photoresist. The end-user may also utilize the camera to monitor the position of beam spot 137 relative to the desired starting point. Because beam spot 133 has been calibrated to coincide with beam spot 137, the alignment of beam spot 137 to the desired starting position results in the alignment of beam spot 133 to the desired starting position.

Referring to FIG. 3, the position sensor 138 detects the position of the x-y translation stage 136 and provides feedback control to adjust the position of the x-y translation stage 136. The position sensor 138 may be any standard position sensor used to sense the position of a translation stage, such as an interferometer, capacitive position sensor, or linear variable differential transformer (LVDT).

The z-axis translation stage 134 translates the position of the substrate 132 along the z-axis to focus the beam spot onto the photoresist material 135. Suitable cameras, steering mirrors, position sensors and x-y translation stages, and a z-axis translation stage for use with the present invention will be understood by one of skill in the art.

The rotation of the two-dimensional scanning mirror 128 along axes 129 and 131 translates the beam spot 133 over the surface of the photoresist material 135 about two orthogonal axes, i.e. x and y. The photoresist material 135 contains a photoactive component and the beam spot 133 induces a physical or chemical change in the photoactive component, more commonly known in the art as photoresist “exposure”. The trajectory of the beam spot 133 traces an exposure pattern or scanning pattern along the x, y and z axes.

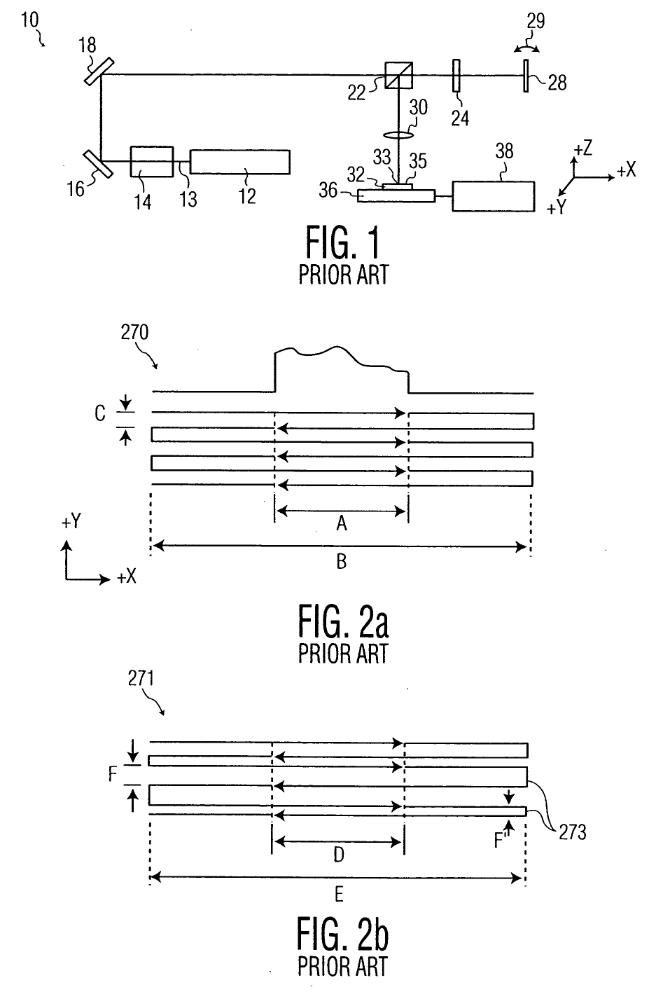

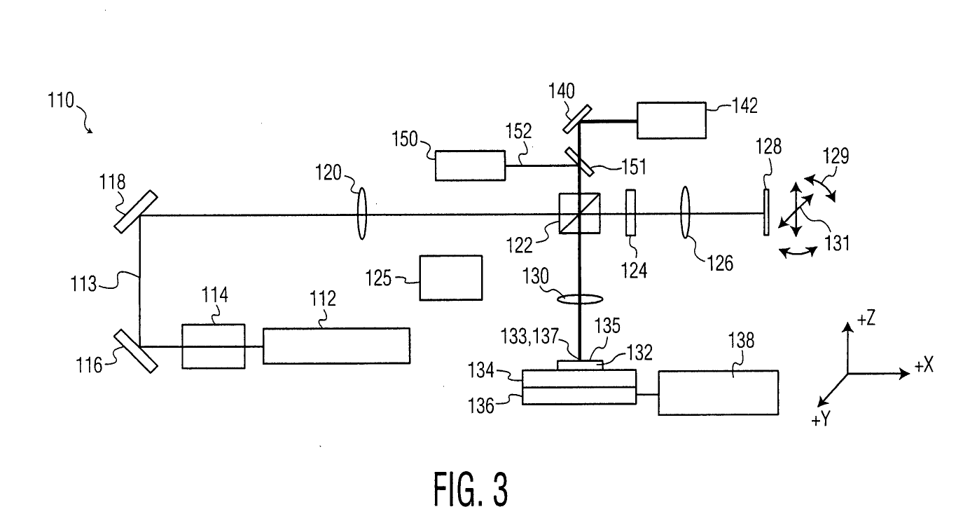

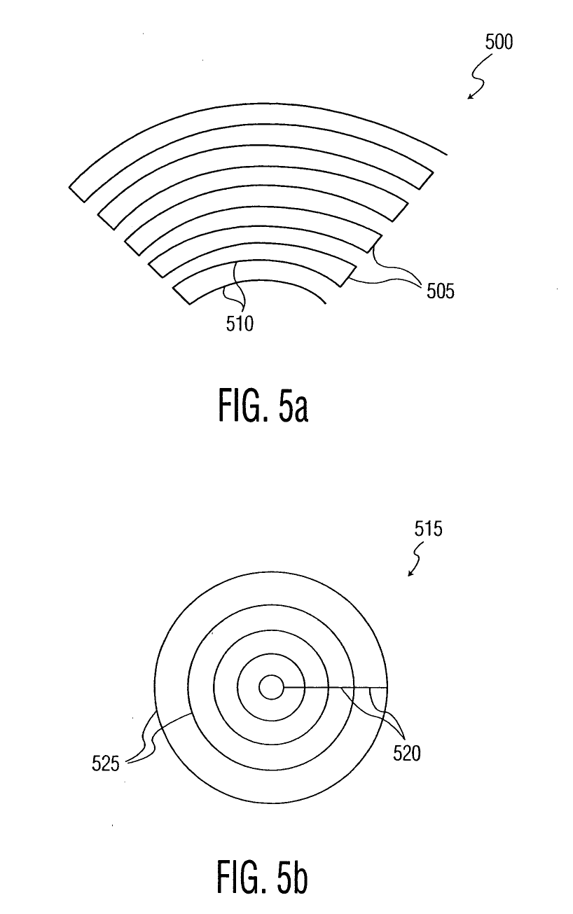

The x-y-axis translation stage 136 is configured to periodically translate the substrate 132 along the y-axis between successive scan fields represented in FIG. 4b as scan field 470 and scan field 470′. The x-y-axis translation stage 136 translates periodically because the two-dimensional scanning mirror 128 is only capable of scanning a single scan field 470, as the scanning range of the two-dimensional scanning mirror 128 is limited by its maximum tilt angle. In the exemplary embodiment, the x-y-axis translation stage 136 translates the substrate 132 by a distance “L” to permit the two-dimensional scanning mirror 128 to scan subsequent scan field 470′. In contrast, the x-y-axis translation stage 36 of the prior art embodiment illustrated in FIGS. 1, 2a and 2b continuously translates the substrate to scan each vertical line of the scan field 270, 271. The exemplary embodiment relies upon the precision of the x-y-axis translation stage 136 less, thereby enabling the exemplary embodiment pattern generator 110 to scan a pattern faster and more precisely than the prior art embodiment pattern generator 10.

In the exemplary embodiment, a microcontroller 125 is coupled to the optical modulator 114, two-dimensional scanning mirror 128, x-y-axis translation stage 136 and z-axis translation stage 134. For the sake of clarity, the connections between the microcontroller and the individual components are not illustrated in FIG. 3. The microcontroller controls the translation of the x-y-axis translation stage 136 and rotation of the mirror 128 to scan or write a two-dimensional image onto the photoresist material 135. The microcontroller also controls the modulation of the optical modulator 114 which regulates the z-axis exposure depth of the photoresist material 135. The microcontroller additionally controls the translation of the z-axis translation stage 134, which controls the focus of the light beam on the photoresist material 135. In an alternative embodiment, the z-axis translation stage 134 may continuously translate to focus the beam spot onto a non-planar substrate surface 135.

In the exemplary embodiment, the mass of the two-dimensional scanning mirror 128 is small enough to enable the two-dimensional scanning mirror 128 to scan smooth and accurate scan lines down to at least the submicron level. These smooth and accurate scans result in a smooth exposure of the photoresist material 135 along the two orthogonal axes, i.e., x and y. The mirror 128 incorporates one or more actuators which rotate the mirror portion with respect to the body portion of the mirror 128. The motion of the actuator is controlled by the microcontroller 125. A suitable scanning mirror 128 is currently sold and distributed by MEMS Optical Incorporated of Huntsville, Ala., USA.

The exemplary embodiment 110 illustrated in FIG. 3 is an improvement over the prior art laser beam pattern generator 10 illustrated in FIG. 1. The prior art laser beam pattern generator 10 is provided with a one-dimensional scanning mirror 28 and a continuously translating x-y-axis translation stage 36. The x-y-axis translation stage 36 of the prior art embodiment is not precise enough to scan uniformly even lines onto a substrate at the micron or submicron accuracy level, as a result of micro-vibrations stemming from the imperfections of the micro-stepping motors that drive the x-y translation stage 36. The motion of the stage 36 is non-uniform, yielding uneven scan lines 273 as shown in FIG. 2b. In contrast, the laser beam pattern generator 110 of the exemplary embodiment is provided with a two-dimensional scanning mirror 128 and a periodically translating x-y translation stage 136. The two-dimensional scanning mirror 128 scans along two axes on the substrate and is accurate to the sub-micron level. The x-y translation stage 136 of the exemplary embodiment is not required to continuously translate the substrate to scan each line of the scan field.

The raster scan fields illustrated in FIGS. 4a and 4b are examples of patterns which the laser beam pattern generator 110 is capable of scanning. Referring to FIG. 4a, to form the raster scan pattern the beam spot 133 starts at point “A” and scans from left to right along the x-axis, steps down along the y-axis, and scans from right to left until the beam spot 133 reaches point “B”.

In this exemplary embodiment, the beam spot 133 scans the entire distance “H” along the x-axis, by virtue of the rotation of the two-dimensional scanning mirror 128. The beam spot 133 also scans along the y-axis, designated step distance “J”, also by virtue of the rotation of the two-dimensional scanning mirror 128. Although a single scan field 470 is shown in FIG. 4a, a scan pattern may be composed of a plurality of scan fields 470, 470′ as illustrated in FIG. 4b. After the beam spot 133 scans the scan field 470, the x-y translation stage 136 translates the substrate a distance “L” along the y-axis so that the beam spot 133 may scan the subsequent field 470′. The position sensor 138 detects the position of the x-y translation stage 136 moving from scan field 470 to scan field 470′ and adjusts the position of stage 136 through feedback control, as required.

Referring to the exemplary embodiment illustrated in FIG. 4a, although the beam spot 133 scans along the entire scan field 470, the beam spot 133 exposes only the portion of the scan field designated by the distance “G”. The beam spot power and/or wavelength is adjusted to expose the photoresist material 135 as the beam spot 133 scans and writes over the distance designated by “G”. The beam spot 133 merely scans over the distances designated by “I” as the beam spot power is not sufficient to expose the photoresist material 135.

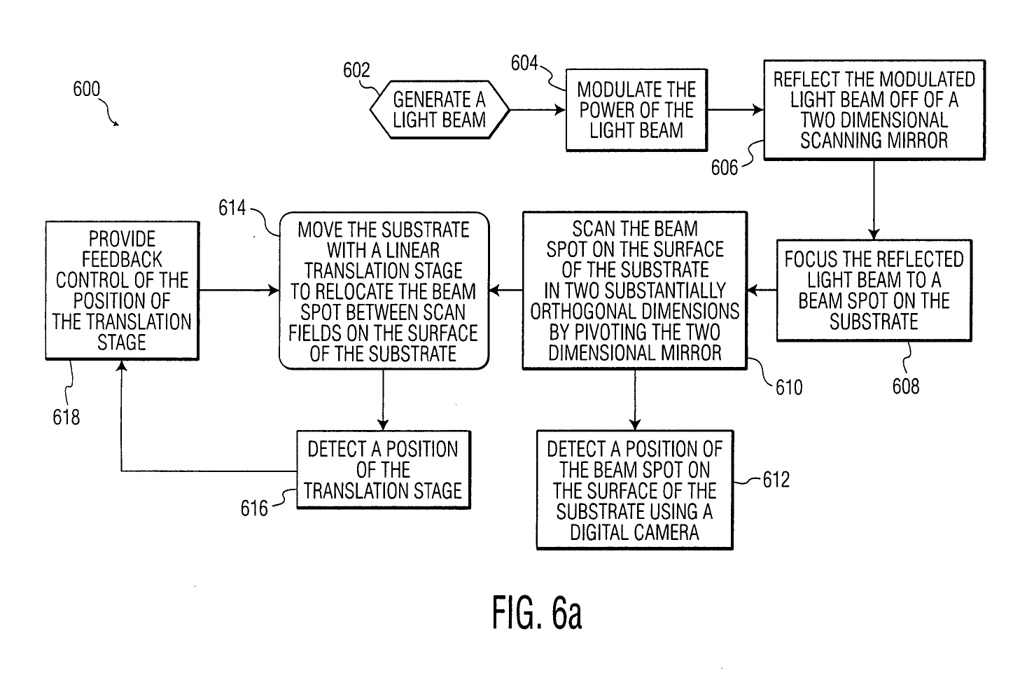

The laser beam pattern generator 110 is not limited to scanning raster scans as illustrated in FIGS. 4a and 4b. The laser beam pattern generator 110 is capable of scanning any pattern. For example, two common curved scanning patterns are illustrated in FIGS. 5a and 5b.

The circular wedge scanning pattern 500 illustrated in FIG. 5a may be useful for scanning features with angular symmetry, triangular symmetry or multi-fold feature onto a substrate. In this example, the beam spot continuously scans along two axes (i.e. x and y) to scan the entire circular wedge pattern. The beam spot 133 scans along the straight portions 505 of the wedge pattern and writes along the curved portions 510 of the wedge pattern.

The closed curve scanning pattern 515 illustrated in FIG. 5b may be desirable to fabricate a Fresnel lens pattern with a circular or elliptical pattern onto a substrate, for example. In this example, the beam spot continuously scans along two axes (i.e. x and y) to scan the entire closed curve portions 525 and scans along the x-axis to scan the straight portions 520. The laser beam scans along the straight portions 520 of the closed curve pattern and writes along the closed curved portions 525 of the closed curve pattern.

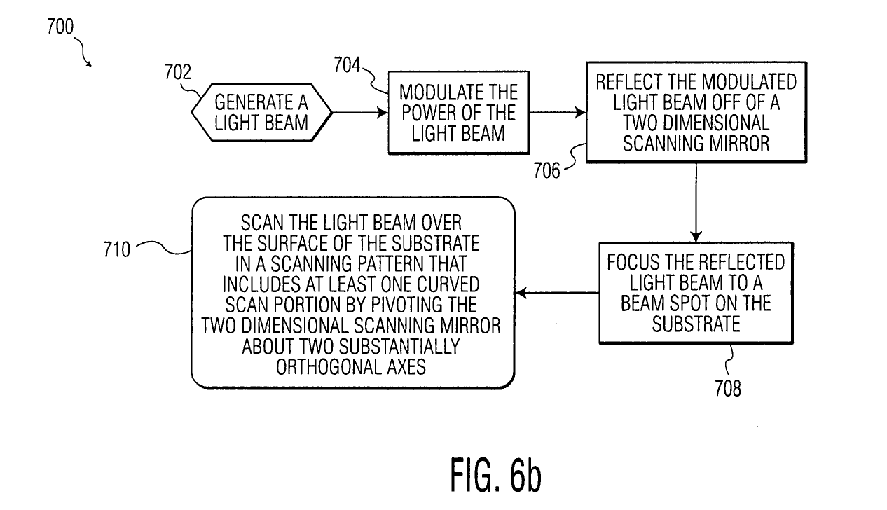

FIG. 6a is a flow chart 600 of exemplary steps for generating a grayscale pattern on a substrate 132 coated with photoresist material 135 in accordance with the present invention. At block 602 a light source 112 generates a light beam 113, which is optionally optically polarized. At block 604 an optical modulator 114 modulates the power of the light beam 113. At block 606 the modulated light beam 113 reflects off of a two dimensional scanning mirror 128. At block 608 a lens 130 focuses the reflected light beam to a beam spot 133 on the surface of a substrate 132. At block 610 a two dimensional mirror 128 pivots about two substantially orthogonal axes 129, 131 to scan the beam spot 133 over the surface of the substrate 132 in two substantially orthogonal dimensions. In an exemplary embodiment, the two dimensional mirror scans with sub-micron accuracy. Optionally, at block 612 a digital camera 142 detects a position of the beam spot 133 on the surface of the substrate 132. It should be understood by one skilled in the art that block 612 is not required to generate a grayscale pattern on a substrate. At block 614 a linear translation stage 134 translates the substrate 132 to move the beam spot 133 between scan fields 470, 470′ on the surface of the substrate 132. At block 616 a position sensor 138 detects the position of the translation stage 134 and at block 618 the position sensor provides feedback control to adjust the position of the translation stage 134, as necessary.

FIG. 6b is a flow chart 700 of exemplary steps for generating a grayscale pattern on a substrate 132 coated with photoresist material 135 in accordance with the present invention. The grayscale pattern produced by the exemplary steps of FIG. 6b includes at least one curved portion along the surface of the substrate 132. At block 702 a light source 112 generates a light beam 113, which is optionally optically polarized. At block 704 an optical modulator 114 modulates the power of the light beam 113. At block 706 the modulated light beam 113 reflects off of a two dimensional scanning mirror 128. At block 708 a lens 130 focuses the reflected light beam to a beam spot 133 on the surface of the substrate 132. At block 710 the two dimensional scanning mirror 128 pivots about two substantially orthogonal axes 129, 131 to scan the light beam 113 over the surface of the substrate in a scanning pattern that includes at least one curved scan portion.

By way of non-limiting example, the grayscale photolithography process may be used to fabricate a tool die, which may be, in turn, used to mold optical lenses. Photoresist material is first applied evenly to a surface of a hard metallic plate. The metallic plate is placed onto the translation stages in preparation for the grayscale photolithography process. The beam spot of alternating power exposes portions of the photoresist material along the x, y, and z axes of the metal plate, creating a three dimensional exposure pattern in the photoresist layer. The three dimensional pattern of exposed photoresist is then removed from the metal plate by a chemical etching process. A negative three dimensional pattern of un-exposed photoresist material remains on the surface of the metallic plate.

The hard metallic plate is installed into a reactive ion etching chamber to create a concave mold pattern. The reactive ion etching chamber bombards the entire surface of the photoresist with energetic ions in a uniform fashion. The reactive ion etching process is commonly known to one skilled in the art. The energetic ions dislodge atoms from the photoresist material, in effect achieving material removal. After the energetic ions have dislodged the atoms of the photoresist material, the energetic ions then dislodge the atoms of the metallic plate in a uniform fashion. The previous exposed unexposed photoresist pattern is duplicated on the surface of the metallic plate. The resulting plate is a concave mold pattern in the hard metallic plate which may be used as a tool die to mold multiple optical lenses for a number of applications, e.g., DVD players, cell phone cameras.

Although the invention is illustrated and described herein with reference to specific embodiments, the invention is not intended to be limited to the details shown. Various other modifications may be made in the details within the scope and range of equivalents of the claims and without departing from the invention. For example, the arrangement of optical components 114, 116, 118 and 120 is not limited to what is shown in the exemplary embodiment. Additionally, the light beam 113 could propagate through a fiber optic cable. In such case, the fiber optic cable would span from the light source 112 to the polarizing beam splitter 122 and the optical modulator 114 could be a variable optical attenuator or a Mach-Zender modulator that are compatible with fiber optic cable.

What is claimed:

1. An optical pattern generator for use in grayscale photolithography, comprising:
an optical source to generate a light beam;
an optical modulator optically coupled to the optical source to modulate the power of the light beam;
a two dimensional scanning mirror optically coupled to the optical modulator to reflect the light beam;
a lens optically coupled to the two dimensional scanning mirror for focusing the reflected light beam to a beam spot on a surface of a substrate coated with photoresist; and
control means electrically coupled to the two dimensional scanning mirror to control a tilt of the two dimensional scanning mirror about two substantially orthogonal axes to scan the beam spot over a surface of the substrate in two substantially orthogonal dimensions with sub-micron accuracy.

2. The optical pattern generator of claim 1, wherein said optical source is a laser source.

3. The optical pattern generator of claim 1, wherein said optical modulator includes at least one of an acousto-optic modulator or an electro-optic modulator.

4. The optical pattern generator of claim 1, further comprising a translation stage coupled to the substrate;
wherein said control means is electrically coupled to the translation stage to control the position of the substrate along at least one of the two substantially orthogonal dimensions.

5. The optical pattern generator of claim 4, further comprising a position sensor coupled to the translation stage and electrically coupled to the control means to determine a position of the translation stage and to provide a position signal to the control means;
wherein the control means provides feedback control of the position of the translation stage based on the position signal of the position sensor.

6. The optical pattern generator of claim 1, further comprising a Z-axis translation stage coupled to the substrate to move the substrate along a direction substantially parallel to the light beam.

7. The optical pattern generator of claim 6, wherein said surface of said substrate is non-planar.

8. The optical pattern generator of claim 1, wherein said lens is a two dimensional scan lens.

9. A method of generating a grayscale pattern having sub-micron accuracy on a substrate coated with photoresist, the method comprising the steps of:
a) generating a light beam;
b) modulating the power of the light beam;
c) reflecting the modulated light beam off of a two dimensional scanning mirror;
d) focusing the reflected light beam to an exposure beam spot on the substrate; and
e) scanning the exposure beam spot on the surface of the substrate in two substantially orthogonal dimensions with sub-micron accuracy by pivoting the two dimensional mirror about two substantially orthogonal axes.

10. The method of claim 9, further comprising the step of:
f) monitoring a position of the exposure beam spot on the surface of the substrate using a digital camera.

11. The method of claim 9, further comprising the step of:
f) moving the substrate with a linear translation stage to relocate the exposure beam spot between scan fields on the surface of the substrate.

12. The method of claim 11, further comprising the steps of:
g) using a position sensor coupled to the linear translation stage to detect a position of the translation stage; and
h) providing feedback control of the position of the translation stage.

13. The method of claim 11, step (d) includes the steps of:
d1) generating an alignment light beam;
d2) focusing the alignment light beam to an alignment beam spot on a calibration surface;
d3) aligning the exposure beam spot with the alignment beam spot on the calibration surface;
d4) monitoring a position of the alignment beam spot using a digital camera; and
d5) moving the substrate with a linear translation stage to align and focus the alignment beam spot to an initial position on the surface of the substrate.

14. The method of claim 13, wherein step (d3) includes focusing the exposure beam spot using a lens to match the focus of the alignment beam spot on the calibration surface.

15. An optical pattern generator for use in grayscale photolithography comprising:
an optical source to generate a light beam;
an optical modulator optically coupled to the optical source to modulate a power of the light beam;
a two dimensional scanning mirror optically coupled to the optical modulator to reflect the modulated light beam;
a lens optically coupled to the two dimensional scanning mirror for focusing the reflected light beam to a beam spot on a surface of a substrate; and
control means electrically coupled to the two dimensional scanning mirror to control a tilt of the two dimensional scanning mirror about two substantially orthogonal axes to scan the beam spot along a scanning pattern over the surface of the substrate;
wherein the scanning pattern includes at least one curved portion.

16. The optical pattern generator of claim 15, wherein the at least one curved portion of the scanning pattern forms at least one closed curve.

17. The optical pattern generator of claim 15, wherein at least one curved portion includes at least one curved scan line.

18. A method of generating a grayscale pattern on a substrate having a surface coated with photoresist comprising the steps of:
a) generating a light beam;
b) modulating the power of the light beam;
c) reflecting the light beam off of a two dimensional scanning mirror;
d) focusing the light beam to a beam spot on the surface of the substrate; and
e) scanning the light beam over the surface of the substrate in a scanning pattern that includes at least one curved scan portion by pivoting the two dimensional scanning mirror about two substantially orthogonal axes.

19. The method of claim 18, wherein step (e) includes the step of scanning the beam spot over the surface of the substrate in at least one closed curve.

20. The method of claim 18, wherein step (e) includes the step of scanning the beam spot over the surface of the substrate in at least one curved scan line.

21. The method of claim 18, wherein step (e) includes the step of scanning the beam spot over the surface of the substrate in a plurality of curved scan lines separated by steps of a predetermined distance.
